(19) United States
(12) Patent Application Publication
(10) Pub. No.: US 2015/0072113 A1
(43) Pub. Date: Mar. 12, 2015

(54) METALIZED FABRIC

(71) Applicant: Encompass Group, LLC, McDonough, GA (US)

(72) Inventor: Kelley Terrell, Ferris, TX (US)

(73) Assignee: Encompass Group, LLC, McDonough, GA (US)

(21) Appl. No.: 14/025,347

(22) Filed: Sep. 12, 2013

(51) Int. Cl. B32B 5/02; B32B 37/14; B32B 37/00; B32B 7/14; B32B 15/085

(52) U.S. Cl. CPC B32B 5/022; B32B 7/14; B32B 15/085; B32B 37/0076; B32B 37/14
USPC 428/196; 442/379; 156/145

(57) ABSTRACT

A metalized fabric (10) is disclosed a first layer (15) of clear thermoplastic material, a second layer (16) of vaporized aluminum material (metalized layer), a third layer (17) of thermoplastic material, and a fourth layer (18) of lofted billow spunbond thermoplastic material. The four layers are sealed together in a pattern that forms a series, matrix or field of large pillowed areas or regions (20) surrounded at four sides by smaller pillowed regions (21). The seals (23) are non-continuous or fragmented, as they are formed by several unjoined segments (24) which provide a less stiff feel to the metalized fabric.

### TECHNICAL FIELD

This invention relates generally to fabrics, and more particularly to metalized fabrics.

### BACKGROUND OF THE INVENTION

Insulative blankets and the like have been made for centuries. Such blankets have traditionally been made of a wool or cotton cloth. These materials have provided a certain amount of heat retaining qualities, however, they are not optimal for such a task.

It has recently been discovered that blankets and clothing may be made of a metalized material to provide the added benefit of infrared heat reflecting capabilities to better prevent heat loss from a person. These products may be used as outdoor blankets, medical patient coverings, or other clothing wherein the conservation of body heat is desired. These metalized fabrics however are usually stiff and not soft to the touch.

Encompass Group, LLC has provided a metalized fabric material under the tradename Thermoflect for many years. This metalized fabric has four discrete layers which are bonded together to form the fabric. These four layers include a clear polyethylene layer, a vaporized aluminum layer, a second polyethylene layer, and a smooth surface spunbond polypropylene layer, these layers being recited in sequence from an exterior surface to an interior surface facing a person donning an article incorporating the fabric. It would be desirous to have a metalized fabric material which is softer to the touch and less stiff to provide better draping and loft character sties.

It would be beneficial to provide a metalized material which is flexible and soft to the touch so that it may be more suitable for use upon a person than those of the prior art. Accordingly, it is to the provision of such that the present invention is primarily directed.

### SUMMARY OF THE INVENTION

In a preferred form of the invention, a metalized fabric comprises a first layer of a thermoplastic material, a second layer of a vaporized metal material overlaying the first layer, a third layer of a thermoplastic material overlaying the second layer opposite the first layer, and a fourth layer of a lofted spunbond thermoplastic material overlaying the third layer opposite the second layer.

In another preferred form of the invention, a method of manufacturing a metalized fabric comprises the steps of (a) providing a first layer of a thermoplastic material, (b) providing a second layer of a vaporized metal material, (c) providing a third layer of a thermoplastic material, (d) providing a fourth layer of thermoplastic material, and (e) sealing the first layer, second layer, third layer and fourth layer together to form a field of lofted, billowed area within the fourth layer of thermoplastic material.

### BRIEF DESCRIPTION OF THE DRAWINGS

FIG. 1 is a perspective view of a metalized fabric embodying principles of the invention in a preferred form.

FIG. 2 is a cross-sectional view of a portion of the metalized fabric of FIG. 1.

FIG. 3 is a top view of a portion of the metalized fabric of FIG. 1.

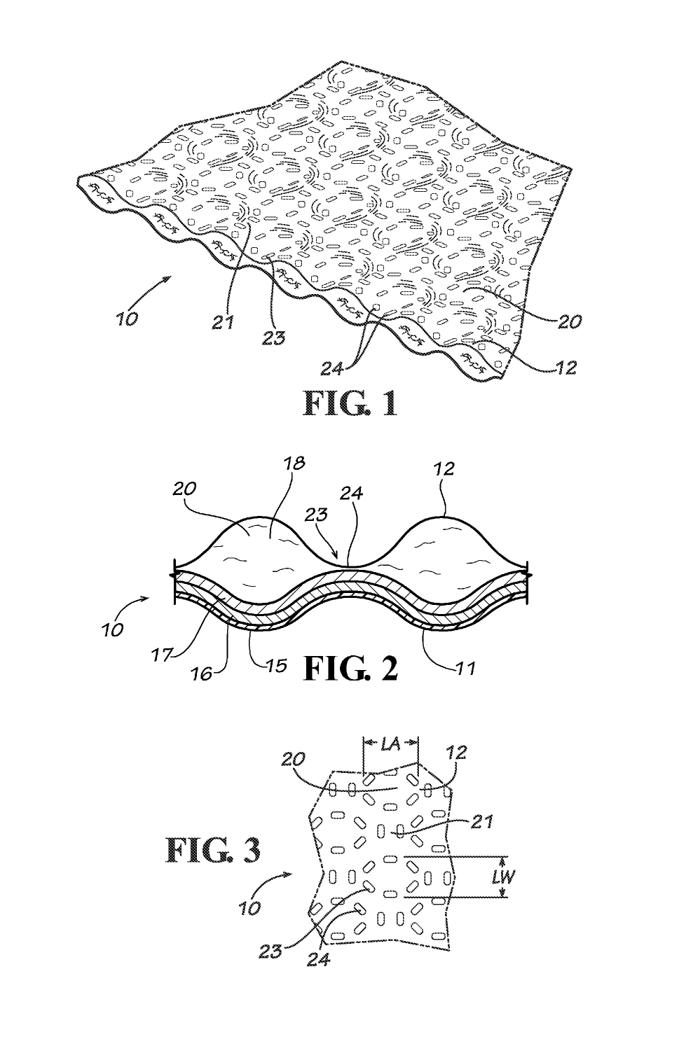

### DETAILED DESCRIPTION

With reference next to the drawings, there is shown a metalized fabric 10 embodying principles of the invention in a preferred form. The metalized. fabric 10 has a tower surface 11 which is intended to face away from a person donning the material and an upper surface 12 which is intended to face the person. The metalized fabric includes a first layer 15 of clear thermoplastic (for example a polyethylene) material, a second layer 16 of vaporized aluminum material (metalized layer), a third layer 17 of thermoplastic (for example a polyethylene) material, and a fourth layer 18 of lofted billow spunbond thermoplastic (for example a polypropylene)non-woven material. The exterior surface of the first layer 15 constitutes the fabric lower surface 11, while the exterior surface of the fourth layer 18 constitutes the upper surface 12.

The metalized fabric is manufactured by extruding the third layer 17 of thermoplastic material onto the fourth layer 18 of spunbond thermoplastic non-woven material. The second layer 16 of vaporized aluminum material is then deposited onto the third layer 17 via a vacuum deposit chamber. The first layer 15 is then extruded onto the second layer 16. The combination of layers is then passed through cold calender rollers which allows the bond pattern of the fourth layer to be visible through the combined structure in a pattern that forms a series, matrix or field of large pillowed areas or regions 20 surrounded at four sides by smaller pillowed regions 21. The large pillowed region 20 is generally oval in shape with a longitudinal length of approximately 3/16 of an inch and a lateral width LW of approximately 2/16 of an inch. The seals 23 themselves are non-continuous or fragmented, as they are formed by several unjoined segments 24 which also helps in providing a less stiff feel to the metalized fabric by breaking up the seals which tend to be stiffer than those areas of the fabric which are not sealed, the bonding of the material at the seals tends to stiffen the sealed areas and thereby tends to stiffen the overall material decreasing its drapability and loft. The metalized fabric of the present invention is fused, bonded or sealed on approximately 14% of the material, as opposed to the prior art material which included at a minimum 18% fusing, bonding or sealing.

The metalized fabric can be used in the construction of a thermal blanket, patient wrap or cocoon, or articles of clothing such as caps, shirts, gowns and the like. While the articles may be described herein in reference to use with medical patients, it should be understood that the use of the fabric is not limited to such,

It is believed that the pillowing of the metalized fabric provides for greater insulative qualities, a softer feel, better glare reduction, improved drapability, and improved loft.

Another discovered advantage has been the materials improved cross-direction tearing resistance. A test was conducted comparing the prior Thermoflect metalized. material, previously described, to the metalized fabric of the present invention. The metalized fabric of the present invention was found to have a cross directional tearing factor of 435.7, while the prior Thermoflect metalized material had a tested cross directional tearing factor of 393. This test shows an improvement in tearing resistance of approximately eleven percent (11%).

It should be understood that as used herein the term “lofted” is intended to mean something that is fluffed, fluffy, expanded, expanded layers, or the like, Also, the term “billow” or “billowed” is intended to mean raised, embossed, undulating surface, having lofted areas, or the like.

It thus is seen that a metalized fabric is now provided which overcomes problems associated with metalized fabrics of the prior art. It should of course be understood that many modifications may be made to the specific preferred embodiment described herein, in addition to those specifically recited herein, without departure from the spirit and scope of the invention as set forth in the following claims.

1. A metalized fabric comprising:
a first layer of a thermoplastic material;
a second layer of a vaporized metal material overlaying said first layer;
a third layer of a thermoplastic material overlaying said second layer opposite said first layer, and
a fourth layer of a lofted spunbond thermoplastic material overlaying said third layer opposite said second layer.

2. The metalized fabric of claim 1 wherein said first layer, said second layer, said third layer and said fourth layer are bonded together along seals.

3. The metalized fabric of claim 2 wherein said seals form a series of pillowed areas.

4. The metalized fabric of claim 3 wherein said seals are fragmented seals.

5. The metalized fabric of claim 1 wherein said first layer of thermoplastic material is a first layer of polyethylene material.

6. The metalized fabric of claim 5 wherein said third layer of thermoplastic material is a third layer of polyethylene material.

7. The metalized fabric of claim 6 wherein said fourth layer of a lofted spunbond thermoplastic material is a fourth layer of a lofted spunbond polypropylene material.

8. A metalized fabric comprising:
a first layer of thermoplastic material having an exterior surface and an interior surface;
a second layer of vaporized aluminum material coupled to said interior surface of said first layer of thermoplastic material;
a third layer of thermoplastic material coupled to said second layer of vaporized aluminum material opposite said first layer of thermoplastic material; and
a fourth layer of billowed spunbond thermoplastic material coupled to said third layer of thermoplastic material opposite said second layer of vaporized aluminum material.

9. The metalized fabric of claim 8 wherein said first layer, said second layer, said third layer and said fourth layer are coupled together through seals.

10. The metalized fabric of claim 9 wherein said seals form a series of lofted areas.

11. The metalized fabric of claim 10 wherein said seals are fragmented seals.

12. A method of manufacturing a metalized fabric comprising the steps of:
(a) providing a first layer of a thermoplastic material;
(b) providing a second layer of a vaporized metal material;
(c) providing a third layer of a thermoplastic material;
(d) providing a fourth layer of thermoplastic material, and
(e) bonding the first layer, second layer, third layer and fourth layer together to form a. field of lofted, billowed area within the fourth layer of polypropylene material.

13. The method of claim 12 wherein step (e) the seals are fragmented seals.

14. The method of claim 12 wherein step (d) the fourth layer of a thermoplastic material is a lofted spunbond polypropylene material.

15. The method of claim 14 wherein step (a) the first layer of a thermoplastic material is a polyethylene material.

16. The method of claim 15 wherein step (c) the third layer of a thermoplastic material is a polyethylene material.
